(19) United States
(12) Patent Application Publication
(10) Pub. No.: US 2025/0180850 A1
(43) Pub. Date: Jun. 5, 2025

(54) ANCHOR STRUCTURALLY CONFIGURED TO ENHANCE PULLING OF A CABLE DURING INSTALLATION

(71) Applicant: BELDEN CANADA ULC, SAINT-LAURENT (CA)

(72) Inventor: Moise LEVY, LAVAL (CA)

(73) Assignee: BELDEN CANADA ULC, SAINT-LAURENT, QC (CA)

(21) Appl. No.: 18/965,884

(22) Filed: Dec. 2, 2024

Related U.S. Application Data
(60) Provisional application No. 63/604,552, filed on Nov. 30, 2023.

(51) Int. Cl. G02B 6/54; H02G 1/08

(52) U.S. Cl. CPC G02B 6/545; H02G 1/088

(57) ABSTRACT

An anchor structurally configured to enhance pulling of a cable during installation may include a cable coupling portion configured to grip a cable. The cable coupling portion may include a body portion and a gripping portion, the body portion may include a cable receiving portion structurally configured to permit a cable to pass through the body portion, and the gripping portion may be structurally configured to engage a cable received in the cable receiving portion. The gripping portion may be structurally configured to engage at least a portion of an outer surface of a jacket of a cable received in the cable receiving portion such that the cable coupling portion is configured to transfer a pulling force applied to the cable coupling portion by a coupled pulling carrier to the cable so as to enhance pulling of the cable during installation of the cable.

### CROSS-REFERENCE TO RELATED APPLICATION

This application claims the benefit of U.S. Provisional Application No. 63/604,552, filed Nov. 30, 2023, which is currently pending, the disclosure of which is hereby incorporated by reference herein in its entirety.

### TECHNICAL FIELD

The present disclosure is directed to an anchor and, more particularly, to a system for physically pulling a grooved cable.

### BACKGROUND

Over time, greater amounts of wired signal pathways are being utilized to transmit digital content. Although wireless signal communications are possible, wired signal pathways are often utilized to enable wireless signal transmission. Such increased use of wired signal carrying pathways corresponds with greater amounts of cables and interconnects to provide a signal network that has the capability to reliably satisfy consumer's demands.

While a variety of different signal carrying cables may be employed to accommodate different installation sites, the physical placement of cables may pose difficulties and challenges. For instance, cables with different diameters, bend capabilities, and environmental protections may be selected based on the type of consumer, physical layout of an installation site, and/or signal transmission needs of the consumer, but may be difficult to physically position on a site, particularly in spaces that are hidden or otherwise inaccessible by hand. Accordingly, various embodiments are directed to a cabling system that allows for efficient cable pulling installation by translating cable grooves into physical features conducive to efficient and accurate cable movement.

Some cables, for example, fiber optic cables, include a low-pressure mold transition that permits the cable to be pulled through a duct, conduit, or the like using a conventional low-pressure mold transition and thus have no way of being pulled. One type of fiber optic cable that may lack such a low-pressure mold transition may be a fiber optic cable having annular grooves.

Accordingly, it may be desirable to provide an anchor that is structurally configured to be coupled with a grooved cable that lacks a low-pressure mold transition so as to provide an anchor point that is structurally configured to permit the cable to be pulled during installation of the cable, for example, with a low-pressure mold pulling eye. In some aspects, it may be desirable to provide an anchor that has an outside geometry that is like a conventional low-pressure mold transition.

### SUMMARY

According to various exemplary aspects of the disclosure, an anchor structurally configured to enhance pulling of a cable during installation may include a cable coupling portion configured to grip a fiber optic cable and a connection portion configured to be coupled with a pulling carrier. The cable coupling portion may include a body portion and a gripping portion, and the body portion may include a cable receiving portion structurally configured to permit a fiber optic cable to pass through the body portion. The gripping portion may be structurally configured to extend radially inward from the body portion towards the cable receiving portion, the cable coupling portion may include a first half portion and a second half portion that are structurally configured to be coupled to one another to surround a fiber optic cable, and the connection portion may include a varying outer diameter along a longitudinal direction of the body portion The gripping portion may be structurally configured to engage a fiber optic cable received in the cable receiving portion, the coupling portion may be structurally configured to extend along less than an entire length of the fiber optic cable in the longitudinal direction, and the connection portion may be structurally configured to be received in an opening of a pulling carrier so as to secure the body portion to the pulling carrier. The cable coupling portion may be structurally configured to be coupled with a cable to provide an anchor point that is structurally configured to be coupled with a pulling carrier via the connection portion. The gripping portion may include a protruding portion structurally configured to extend radially inward from the body portion and to engage at least a portion of a groove in an outer surface of a jacket of a fiber optic cable received in the cable receiving portion such that the cable coupling portion is configured to transfer a pulling force applied to the cable coupling portion by a coupled pulling carrier to the fiber optic cable so as to enhance pulling of the fiber optic cable during installation of the fiber optic cable.

In some embodiments of the aforementioned anchor, the protruding portion may include a plurality of protrusions structurally configured to extend radially inward from the body portion and to engage at least a portion of a corresponding plurality of grooves in the outer surface of the jacket of the fiber optic cable received in the cable receiving portion.

In some embodiments of the aforementioned anchors, the first half portion and the second half portion may be identical to one another.

In some exemplary aspects, a pulling arrangement may include one of the aforementioned anchors and a pulling carrier configured to be coupled with the anchor.

In some embodiments of the aforementioned pulling arrangement, the pulling carrier may include a low-pressure mold pulling eye.

In some embodiments of the aforementioned pulling arrangements, the pulling carrier may be configured to receive a pulling cord portion and to transfer a force applied to the pulling cord portion to the anchor so as to enhance pulling of the fiber optic cable during installation of the fiber optic cable.

According to various exemplary aspects of the disclosure, an anchor structurally configured to enhance pulling of a cable during installation may include a cable coupling portion configured to grip a cable and a connection portion configured to be coupled with a pulling carrier. The cable coupling portion may include a body portion and a gripping portion, and the body portion may include a cable receiving portion structurally configured to permit a cable to pass through the body portion. The gripping portion may be structurally configured to extend radially inward from the body portion towards the cable receiving portion, and the gripping portion may be structurally configured to engage a cable received in the cable receiving portion. The connection portion may be structurally configured to be received in an opening of a pulling carrier so as to secure the body portion to the pulling carrier, and the cable coupling portion may be structurally configured to be coupled with a cable to provide an anchor point that is structurally configured to be coupled with a pulling carrier via the connection portion. The gripping portion may include a protruding portion structurally configured to extend radially inward from the body portion and to engage at least a portion of a protruding portion receiving portion in an outer surface of a jacket of a cable received in the cable receiving portion such that the cable coupling portion is configured to transfer a pulling force applied to the cable coupling portion by a coupled pulling carrier to the cable so as to enhance pulling of the cable during installation of the cable.

In some embodiments of the aforementioned anchors, the protruding portion may include a plurality of protrusions structurally configured to extend radially inward from the body portion and to engage at least a portion of a corresponding plurality of protrusion receiving portions in the outer surface of the jacket of the cable received in the cable receiving portion.

In some embodiments of the aforementioned anchors, the cable coupling portion may include a first coupling portion and a second coupling portion that are structurally configured to be coupled to one another to surround a cable. In some aspects, the first coupling portion and the second coupling portion are identical to one another.

In some embodiments of the aforementioned anchors, the connection portion may include a varying outer diameter along a longitudinal direction of the body portion.

In some exemplary aspects, a pulling arrangement may include one of the aforementioned anchors and a pulling carrier configured to be coupled with the anchor.

In some embodiments of the aforementioned pulling arrangement, the pulling carrier may include a low-pressure mold pulling eye.

In some embodiments of the aforementioned pulling arrangements, the pulling carrier may be configured to receive a pulling cord portion and to transfer a force applied to the pulling cord portion to the anchor so as to enhance pulling of the fiber optic cable during installation of the fiber optic cable.

According to various exemplary aspects of the disclosure, an anchor structurally configured to enhance pulling of a cable during installation may include a cable coupling portion configured to grip a cable. The cable coupling portion may include a body portion and a gripping portion, the body portion may include a cable receiving portion structurally configured to permit a cable to pass through the body portion, and the gripping portion may be structurally configured to engage a cable received in the cable receiving portion. The gripping portion may be structurally configured to engage at least a portion of an outer surface of a jacket of a cable received in the cable receiving portion such that the cable coupling portion is configured to transfer a pulling force applied to the cable coupling portion by a coupled pulling carrier to the cable so as to enhance pulling of the cable during installation of the cable.

In some embodiments of the aforementioned anchors, the gripping portion may be structurally configured to extend radially inward from the body portion towards the cable receiving portion, and the gripping portion may be structurally configured to engage a cable received in the cable receiving portion.

Some embodiments of the aforementioned anchors may further include a connection portion configured to be coupled with a pulling carrier. The connection portion may be structurally configured to be received in an opening of a pulling carrier so as to secure the body portion to the pulling carrier, and the cable coupling portion may be structurally configured to be coupled with a cable to provide an anchor point that is structurally configured to be coupled with a pulling carrier via the connection portion. In some aspects, the connection portion may include a varying outer diameter along a longitudinal direction of the body portion.

In some embodiments of the aforementioned anchors, the gripping portion may include a protruding portion structurally configured to extend radially inward from the body portion. In some aspects, the protruding portion may include a plurality of protrusions structurally configured to extend radially inward from the body portion and to engage at least a portion of a corresponding plurality of protrusion receiving portions in the outer surface of the jacket of the cable received in the cable receiving portion.

In some embodiments of the aforementioned anchors, the cable coupling portion may include a first coupling portion and a second coupling portion that are structurally configured to be coupled to one another to surround a fiber optic cable. In some aspects, the first coupling portion and the second coupling portion are identical to one another.

In some exemplary aspects, a pulling arrangement may include one of the aforementioned anchors and a pulling carrier configured to be coupled with the anchor.

In some embodiments of the aforementioned pulling arrangement, the pulling carrier may include a low-pressure mold pulling eye.

In some embodiments of the aforementioned pulling arrangements, the pulling carrier may be configured to receive a pulling cord portion and to transfer a force applied to the pulling cord portion to the anchor so as to enhance pulling of the fiber optic cable during installation of the fiber optic cable.

### BRIEF DESCRIPTION OF THE DRAWINGS

Further advantages and features of the present disclosure will become apparent from the following description and the accompanying drawings, to which reference is made.

FIG. 1 is a line representation of portions of a cable environment in which assorted embodiments of a cable pulling system may be practiced.

FIG. 2 is a line representation of portions of a cable assembly that may be employed in the environment of FIG. 1.

FIG. 3 is a cross-sectional representation of portions of an exemplary anchor in accordance with various embodiments of this disclosure.

FIG. 4 is a perspective view of portions of a cable pulling arrangement, including the exemplary anchor of FIG. 3, in accordance with various embodiments of this disclosure.

FIG. 5 is a perspective view of a cable pulling arrangement, including the exemplary anchor of FIG. 3, configured and operated in accordance with various embodiments of this disclosure.

FIG. 6 is a cross-sectional view of an exemplary anchor, in accordance with various embodiments of this disclosure, arranged with a cable.

FIG. 7 is a side view of the exemplary anchor and cable of FIG. 6.

FIG. 8 is a perspective view of the exemplary anchor illustrated in FIGS. 6 and 7.

### DETAILED DESCRIPTION

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

As wired connections proliferate to provide distributed networks to consumers, greater volumes of cabling are installed in a variety of residential, commercial, and industrial sites. Advancements in network capabilities, such as latency, bandwidth, or signal speed, may contribute to existing cabling being redone, altered, or otherwise replaced. The installation of signal carrying cables can pose challenges in some environments, especially when cables are hidden from view and/or moved relatively long distances. Thus, various embodiments are directed to an anchor that is structurally configured to be coupled with a grooved cable that lacks a low-pressure mold transition so as to provide an anchor point that is structurally configured to permit the cable to be pulled during installation of the cable, for example, with a low-pressure mold pulling eye.

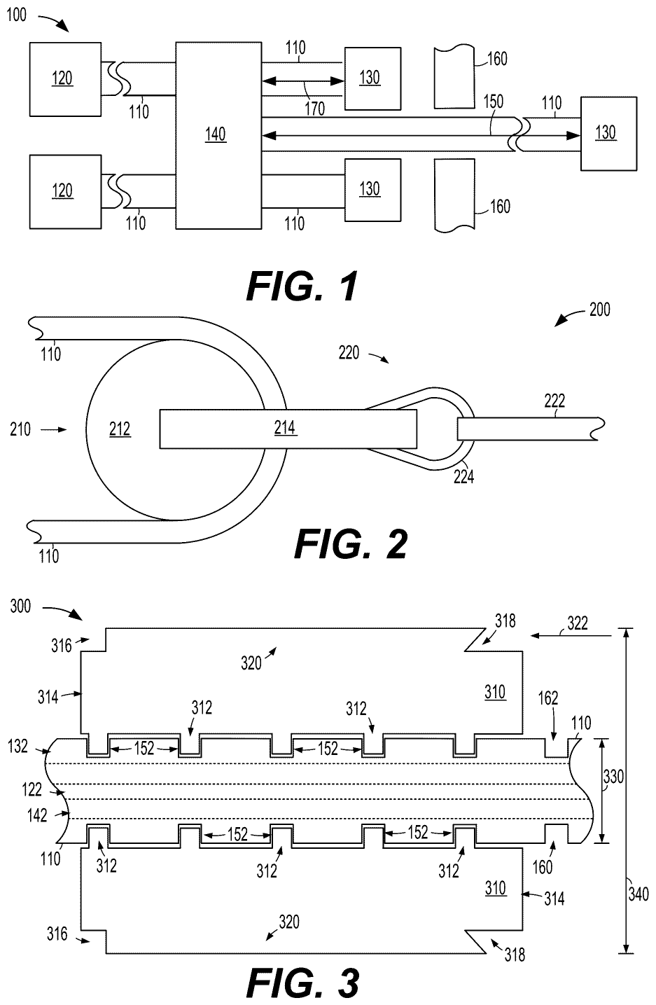

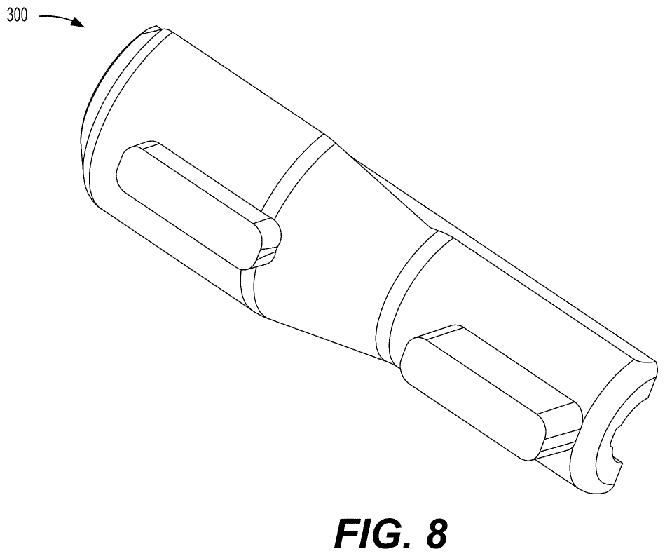

In FIGS. 1-8, assorted aspects of a cable pulling system are displayed. A line representation of a portion of a cable environment 100 is shown in FIG. 1 in which embodiments of a cable pulling system can be practiced. Any number, and type, of cable 110 can provide at least one stable signal pathway between a source 120 to a destination 130. A cable 110 can house one or more signal conductors, such as an electrically conducting wire or optical conduit, that provide two-way communication between the source 120 and destination 130.

While a cable environment 100 may include a single source 120 connected to a single destination 130 via a single, continuously extending cable 110, such configuration is not required as one or more interconnects 140, such as a switch, server, connector, splitter, or other device, can provide one or more stable signal pathways with numerous separate cables 110, as generally shown in FIG. 1. The ability to use one or more interconnects 140 allows for the formation, operation, and maintenance of a distributed network where separate, and potentially different, sources 120 interact with separate, and potentially different, destinations 130.

The use of cables 110 to provide signal pathways, as opposed to wireless signal communications, may establish reliable connections, but can pose challenges during initial installation and during operation over time. For instance, routing cables 110 a distance 150 through one or more obstructions 160, such as walls, housings, or distribution boxes, may be laborious due to the flexible construction of many cables 110 that may be exacerbated by physical spaces including hidden areas, sharp turns, and/or varying topography. Hence, installing a cable 110 for a distance 150 through a duct or obstruction 160 may pose higher risk of faults or unreliable operation over time than a cable 110 installed a distance 170 that is shorter, not through a duct or obstruction 160, and/or not in spaces with hidden or tight physical constraints.

In situations where circumstances are conducive to tool-aided cable 110 installation, such as relatively long cable distances 150 and/or manually inaccessible spaces, for example, ducts or conduits, a cable puller may be employed. FIG. 2 is a line representation of a cable assembly 200 that may be employed in the cable environment 100 of FIG. 1 to establish and maintain a distributed cable network in accordance with various embodiments. The cable assembly 200 includes a cable holder portion 210 that is physically attached to a pulling portion 220 that allows force to be exerted on the cable 110 to induce movement.

It is noted that a cable 110 may be manually, or mechanically, moved with tools, mechanisms, and apparatus other than the assembly 200 shown in FIG. 2. Yet, some embodiments engage a cable with a spinning portion 212 that provides secure physical attachment with a cable 110 as well as rotation capabilities that allow cable 110 deposition along a selected length in response to force applied on the pulling portion 220. The spinning portion 212 may be any wheel, bearing, or cam that rotates relative to the cable 110 and an anchor portion 214 that is physically connected to the pulling portion 220.

The pulling portion 220 has one or more pulling features 222, such as a rope, chain, or tether, that applies force on the cable holder portion 210 via a receiver portion 224, which may be any size, shape, and material to allow selective connection to the cable holder portion 210. It is contemplated that force is applied to the cable 110 via the anchor portion 214 and without the pulling portion 220, but such configuration is not required or limiting.

Through the use of the cable assembly 200, a technician can apply manual, hydraulic, mechanical, or pneumatic force onto the cable 110 to lay the cable 110 along a desired route. However, the size of the cable assembly 200 may be prohibitive in some cable installation environments, such as residential walls or underground conduits. While the size of the spinning portion 212 may be reduced, in some configurations, to lessen the size of the assembly 200, such a reduction may place the cable 110 in a physically compromising arrangement. For instance, a physically small spinning portion 212 may bend the cable 110 to a degree that risks compromising the integrity of the constituent signal carrying features, such as a fiber optic conduit.

A reduction in the size of the spinning portion 212 may further reduce the surface area available to physically secure the cable 110 during deployment. As such, the cable 110 may slip, move, or spin to the detriment of cable 110 installation accuracy, efficiency, and potentially operation. Accordingly, various embodiments utilize a grooved cable 110 that provides heightened physical engagement that allows cable 110 installation without a spinning portion 212 or bulky mechanism for applying force onto a cable 110.

FIGS. 3-8 respectively convey aspects of an anchor 300 that may engage and secure a grooved cable 110 in accordance with various embodiments to provide optimized cable 110 installation without bending the cable 110, as generally shown in FIG. 2.

FIG. 3 illustrates a cross-sectional view of an exemplary anchor 300 that includes a cable coupling portion, or sleeve 310, having a body portion 314 and a gripping portion 312, for example, one or more protrusions that is structurally configured to grip a cable. FIG. 3 illustrates how the sleeve 310 can engage a cable 110. Although not required or limiting, the cable 110 may have a central signal conductor 122, such as a wire, cord, or optical fiber, that is protected by an outer jacket portion 132. Some embodiments of the cable 110 may include one or more intervening materials 142, such as dielectrics, electrical shields, moisture absorption portions, and physical reinforcing portions. The outer jacket portion 132 may have an outer surface that includes a grooved portion 152, for example, a number of annular grooves or annular recesses, that may be continuous, discontinuous, connected, or separate to provide greater surface area and edges to be gripped by the gripping portion 312 than a smooth outer jacket portion 132 would have. It is noted that the grooved portion 152 may be similar or dissimilar throughout a length of the cable 110, along a longitudinal axis of the cable 110, and may be spaced apart at matching, or different, distances.

The sleeve 310 may engage less than all, or an entirety of, a periphery of the cable 110, as measured orthogonal to the longitudinal axis of the cable 110. The physical engagement of the gripping portion 312 with the cable grooves 152 allows for secure engagement and positioning of the body portion 314 relative to the cable 110 as well as efficient translation of force applied to the sleeve 310 to induce movement of the cable 110. It is noted that the gripping portion 312 may physically contact, and at least partially occupy, less than all the cable grooves, as shown by open groove 162.

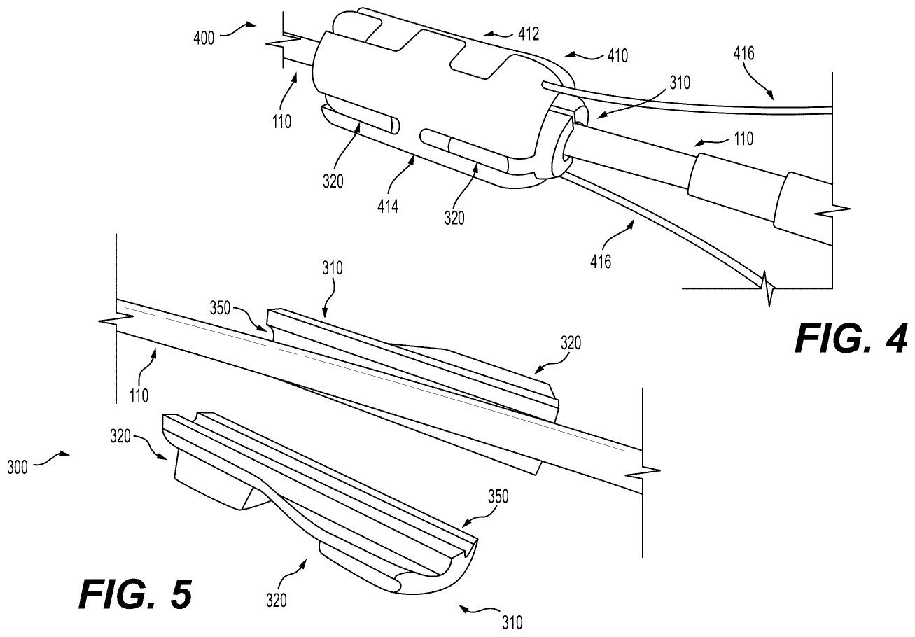

The sleeve 310, in various embodiments, may comprise multiple separate pieces that engage one another to surround the cable 110. Such separate sleeve pieces may have matching, or dissimilar, shapes and sizes that collectively function to engage the cable grooves 152 and securely attach to the cable 110. It is contemplated that the body portion 314 has a uniform cross-sectional shape throughout the longitudinal length, along the longitudinal axis 322. However, some embodiments may provide a varying cross-sectional shape and/or size that allow for efficient attachment of the sleeve 310, and connected cable 110, with additional pulling components, as conveyed in FIG. 4.

A varying cross-sectional sleeve shape may provide connection features 316, 318 that may define a connection portion 320. In the non-limiting embodiment of the sleeve 310 shown in FIG. 3, a first connection feature 316 may comprise a square notch, while a second connection feature 318 may comprise an angled notch 318. The ability to configure the body portion 314 with any number of connection features 316, 318 with matching, or dissimilar, sizes and shapes allows the connection portion 320 to be catered to a diverse variety of arrangements that are conducive to stand-alone pulling and/or attachment of further pulling components. For instance, the connection portion 320 and at least one connection feature 316, 318 can be configured for efficient and safe pulling along the longitudinal axis/direction 322 without additional equipment. Another instance configures the connection portion 320 for secure attachment to additional pulling equipment, as shown in FIG. 4, but such configuration may be less conducive to manual pulling.

Through the secure engagement of the sleeve 310 to the cable 110, as illustrated, the cable diameter 330 can effectively be enlarged to a pulling diameter 340 that includes the transverse dimension of the body portion 314. The greater pulling diameter 340 may effectively translate force along the longitudinal axis/direction 322 into cable 110 movement than the cable 110 alone. In other words, a greater pulling thickness, which corresponds with the larger diameter 340, may allow greater amounts of longitudinal force, and acceleration, to be exerted on the cable 110 to induce movement without physical slipping, sliding, or lost pulling energy.

It is again noted that some embodiments utilize the sleeve 310 alone to pull the cable 110 a selected distance in the longitudinal direction 322. Yet, various embodiments employ multiple pulling components to efficiently produce cable 110 movement, as illustrated in the perspective view of a pulling system 400 in FIG. 4. The pulling system 400 employs a pulling assembly 410, for example, a pulling eye, in some aspects, a low pressure mold (LPM) pulling eye, structurally configured to translate a force into cable 110 movement. The assembly 410 utilizes the coupling portion 310 of the anchor 300 to physically engage portions of a grooved cable 110, as illustrated in FIG. 3, along with a pulling carrier that has a first portion 412 that mates with a second portion 414.

Although the pulling carrier may be configured as a single piece of material that physically attaches to the sleeve 310, various embodiments arrange the respective pulling assembly portions 412, 414 as matching, or dissimilar, halves that physically interact around the sleeve 310 to secure at least one pulling cord 416 to the cable 110 by positioning an end portion 418 of the pulling cord 416 between the coupling sleeve portion 310 and the carrier pulling assembly 410 so that the cord 416 continuously extends from the carrier pulling assembly 410 in a direction parallel to the longitudinal axis 322 of the cable 110 and the direction of pulling force to move the cable 110 during installation, for example, through a duct or conduit. The respective pulling assembly portions 412, 414 can interact with the connection portions 320 of the sleeve 310, as shown, to ensure force applied on the assembly 410 alone, or via a cord 416, translates into cable 110 movement without slippage, spinning, or other actions that rob energy from moving the cable 110. It is contemplated that the pulling assembly 410 is arranged so that force applied in a first longitudinal direction tightens the portions 412, 414 onto the sleeve 310, and force applied in an opposite, second longitudinal direction loosens the portions 412, 414 from the sleeve 310.

The perspective view of FIG. 5 conveys how the body portion 314 of the sleeve 310 can be split into a pair of halves. Such halved configuration for the body portion 314 allows for efficient and accurate installation and subsequent removal without moving the cable 110. The installation and removal of the sleeve 310 can further be conducted without harming or altering the outer jacket of the cable 110, which allows a sleeve 310 to repeatedly engage a selected region of a cable 110 to facilitate cable 110 movement without jeopardizing the integrity or reliability of the cable 110.

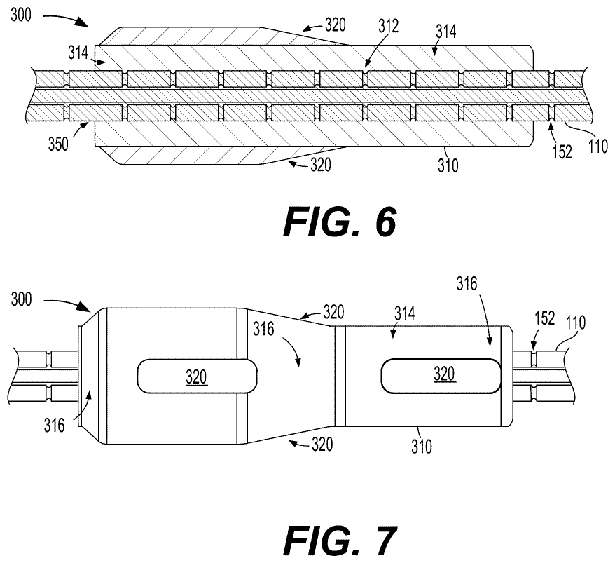

FIGS. 6 and 7 respectively illustrate front and rear plan views of portions of the anchor 300 of FIGS. 3-5 coupled with a cable 110. The front view of FIG. 6 shows how the grooved cable 110 fits partially in a cable receiving portion 350, for example, a channel portion, of the body portion 314. It is noted that the cable receiving portion 350 has a number of protrusions that comprise a gripping portion 312 (best shown in FIG. 3) that individually and collectively engage and, at least partially, occupy separate grooves 152 of the cable 110. The cable receiving portion 350 continuously extends throughout the longitudinal axis of the sleeve 310 to allow the cable 110 to continue beyond the sleeve 310. In other words, the sleeve 310, and particularly the cable receiving portion 350, are arranged to fit around a cable 110 without cutting, bending, or stopping the cable 110.

The body portion 314 presents the connection portion 320 on opposite sides of the cable 110. The connection portion 320 shown in FIG. 6 has tapered edges that respectively slope with respect to the cable 110 and body portion 314. The connection portion 320 may be radially offset from the connection portion 320 shown in FIG. 6, as illustrated in FIG. 7, and have straight edges that can be characterized as orthogonal to the body portion 314 and cable 110. The diverse sizes, shapes, and edge configurations of the connection portion 320 can provide customized attachment capabilities that may increase pulling efficiency with the sleeve 310 alone, or as part of a pulling assembly 410.

In some embodiments, the sleeve 310 employs one or more retention members, such as a band, strap, tie, or fastener, to hold the halves of the sleeve 310 together during pulling operations. For instance, a temporary strap may be positioned in a recess connection feature 316 between separate portions of the connection portion 320 to promote secure engagement of the cable 110 in the cable receiving portion 350 and sturdy retention of the halves of the sleeve 310 in a selected position on the cable 110 with, or without, pulling force applied to the sleeve 310 or cable 110.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. An anchor structurally configured to enhance pulling of a fiber optic cable during installation, comprising:
a cable coupling portion configured to grip a fiber optic cable;
a connection portion configured to be coupled with a pulling carrier;
wherein the cable coupling portion includes a body portion and a gripping portion;
wherein the body portion includes a cable receiving portion structurally configured to permit a fiber optic cable to pass through the body portion;
wherein the gripping portion is structurally configured to extend radially inward from the body portion towards the cable receiving portion;
wherein the cable coupling portion comprises a first half portion and a second half portion that are structurally configured to be coupled to one another to surround a fiber optic cable;
wherein the connection portion includes a varying outer diameter along a longitudinal direction of the body portion;
wherein the gripping portion is structurally configured to engage a fiber optic cable received in the cable receiving portion;
wherein the coupling portion is structurally configured to extend along less than an entire length of the fiber optic cable in the longitudinal direction;
wherein the connection portion is structurally configured to be received in an opening of a pulling carrier so as to secure the body portion to the pulling carrier;
wherein the cable coupling portion is structurally configured to be coupled with a cable to provide an anchor point that is structurally configured to be coupled with a pulling carrier via the connection portion; and
wherein the gripping portion comprises a protruding portion structurally configured to extend radially inward from the body portion and to engage at least a portion of a groove in an outer surface of a jacket of a fiber optic cable received in the cable receiving portion such that the cable coupling portion is configured to transfer a pulling force applied to the cable coupling portion by a coupled pulling carrier to the fiber optic cable so as to enhance pulling of the fiber optic cable during installation of the fiber optic cable.

2. The anchor of claim 1, wherein the protruding portion comprises a plurality of protrusions structurally configured to extend radially inward from the body portion and to engage at least a portion of a corresponding plurality of grooves in the outer surface of the jacket of the fiber optic cable received in the cable receiving portion.

3. The anchor of claim 1, wherein the first half portion and the second half portion are identical to one another.

4. A pulling arrangement comprising:
the anchor of claim 1; and
a pulling carrier configured to be coupled with the anchor.

5. The pulling arrangement of claim 4, wherein the pulling carrier comprises a low-pressure mold pulling eye.

6. The pulling arrangement of claim 4, wherein the pulling carrier is configured to receive a pulling cord portion and to transfer a force applied to the pulling cord portion to the anchor so as to enhance pulling of the fiber optic cable during installation of the fiber optic cable.

7. An anchor structurally configured to enhance pulling of a cable during installation, comprising:
a cable coupling portion configured to grip a cable;
a connection portion configured to be coupled with a pulling carrier;
wherein the cable coupling portion includes a body portion and a gripping portion;
wherein the body portion includes a cable receiving portion structurally configured to permit a cable to pass through the body portion;
wherein the gripping portion is structurally configured to extend radially inward from the body portion towards the cable receiving portion;
wherein the gripping portion is structurally configured to engage a cable received in the cable receiving portion;
wherein the connection portion is structurally configured to be received in an opening of a pulling carrier so as to secure the body portion to the pulling carrier;
wherein the cable coupling portion is structurally configured to be coupled with a cable to provide an anchor point that is structurally configured to be coupled with a pulling carrier via the connection portion; and
wherein the gripping portion comprises a protruding portion structurally configured to extend radially inward from the body portion and to engage at least a portion of a protruding portion receiving portion in an outer surface of a jacket of a cable received in the cable receiving portion such that the cable coupling portion is configured to transfer a pulling force applied to the cable coupling portion by a coupled pulling carrier to the cable so as to enhance pulling of the cable during installation of the cable.

8. The anchor of claim 7, wherein the protruding portion comprises a plurality of protrusions structurally configured to extend radially inward from the body portion and to engage at least a portion of a corresponding plurality of protrusion receiving portions in the outer surface of the jacket of the cable received in the cable receiving portion.

9. The anchor of claim 7, wherein the cable coupling portion comprises a first coupling portion and a second coupling portion that are structurally configured to be coupled to one another to surround a cable.

10. The anchor of claim 9, wherein the first coupling portion and the second coupling portion are identical to one another.

11. The anchor of claim 7, wherein the connection portion includes a varying outer diameter along a longitudinal direction of the body portion.

12. A pulling arrangement comprising:
the anchor of claim 7; and
a pulling carrier configured to be coupled with the anchor.

13. The pulling arrangement of claim 12, wherein the pulling carrier comprises a low-pressure mold pulling eye.

14. The pulling arrangement of claim 12, wherein the pulling carrier is configured to receive a pulling cord portion and to transfer a force applied to the pulling cord portion to the anchor so as to enhance pulling of the cable during installation of the cable.

15. An anchor structurally configured to enhance pulling of a cable during installation, comprising:
a cable coupling portion configured to grip a cable;
wherein the cable coupling portion includes a body portion and a gripping portion;
wherein the body portion includes a cable receiving portion structurally configured to permit a cable to pass through the body portion;
wherein the gripping portion is structurally configured to engage a cable received in the cable receiving portion; and
wherein the gripping portion is structurally configured to engage at least a portion of an outer surface of a jacket of a cable received in the cable receiving portion such that the cable coupling portion is configured to transfer a pulling force applied to the cable coupling portion by a coupled pulling carrier to the cable so as to enhance pulling of the cable during installation of the cable.

16. The anchor of claim 15, wherein the gripping portion is structurally configured to extend radially inward from the body portion towards the cable receiving portion; and
wherein the gripping portion is structurally configured to engage a cable received in the cable receiving portion.

17. The anchor of claim 15, further comprising a connection portion configured to be coupled with a pulling carrier;
wherein the connection portion is structurally configured to be received in an opening of a pulling carrier so as to secure the body portion to the pulling carrier; and
wherein the cable coupling portion is structurally configured to be coupled with a cable to provide an anchor point that is structurally configured to be coupled with a pulling carrier via the connection portion.

18. The anchor of claim 17, wherein the connection portion includes a varying outer diameter along a longitudinal direction of the body portion.

19. The anchor of claim 15, wherein the gripping portion comprises a protruding portion structurally configured to extend radially inward from the body portion.

20. The anchor of claim 19, wherein the protruding portion comprises a plurality of protrusions structurally configured to extend radially inward from the body portion and to engage at least a portion of a corresponding plurality of protrusion receiving portions in the outer surface of the jacket of the cable received in the cable receiving portion.

21. The anchor of claim 15, wherein the cable coupling portion comprises a first coupling portion and a second coupling portion that are structurally configured to be coupled to one another to surround a fiber optic cable.

22. The anchor of claim 21, wherein the first coupling portion and the second coupling portion are identical to one another.

23. A pulling arrangement comprising:
the anchor of claim 15; and
a pulling carrier configured to be coupled with the anchor.

24. The pulling arrangement of claim 23, wherein the pulling carrier comprises a low-pressure mold pulling eye.

25. The pulling arrangement of claim 23, wherein the pulling carrier is configured to receive a pulling cord portion and to transfer a force applied to the pulling cord portion to the anchor so as to enhance pulling of the cable during installation of the cable.
